(19) United States
(12) Patent Application Publication
(10) Pub. No.: US 2004/0262237 A1
(43) Pub. Date: Dec. 30, 2004

(54) Process for separating particulates from a low dielectric fluid

(76) Inventors: Ralph E. Kornbrekke, Chagrin Falls, OH (US); Richard M. Webber, Brookline, MA (US)

Correspondence Address: THE LUBRIZOL CORPORATION, Patent Administrator - Mail Drop 022B, 29400 Lakeland Boulevard, Wickliffe, OH, 44092-2298, US

(21) Appl. No.: 10/859,250

(22) Filed: Jun. 2, 2004

Related U.S. Application Data
(60) Provisional application No. 60/475,742, filed on Jun. 4, 2003.

(51) Int. Cl. B01D 43/00

(52) U.S. Cl. 210/748; 123/1 R

(57) ABSTRACT

This invention relates to a process for separating particulates from a low dielectric fluid containing such particulates, the process comprising: contacting the particulates with an acidic organic compound, a metal salt of an acidic organic compound, a basic organic compound, or a mixture of two or more thereof; applying an electric field to the low dielectric fluid; forming a particulates-lean phase and a particulates-rich phase in the dielectric fluid; and separating the particulates-lean phase from the particulates-rich phase. This process is particularly suitable for separating particulates from the lubricating oil of an internal combustion during the operation of the engine.

This application claims priority from U.S. Provisional Application Ser. No. 60/475,742 filed Jun. 4, 2003.

### TECHNICAL FIELD

This invention relates to a process for separating particulates from low dielectric fluids. This invention is particularly suitable for removing particulates from internal combustion engine oils (e.g., diesel engine oils) during the operation of the engine.

### BACKGROUND OF THE INVENTION

Consumer desire to move to longer intervals between oil changes and pending regulatory requirements for exhaust gas recirculation threaten to significantly increase the volume fraction of soot loaded into diesel engine lubricants during their service life in the engine. Properly dispersed and stabilized, the effects of soot on lubricant rheology can be minimized. However, even for optimal dispersion, relative lubricant viscosity still increases strongly with soot volume fraction, often diverging as the soot volume fraction increases beyond 0.10. With poor dispersion, the effective soot volume fraction may be significantly greater than that evident from the mass of added soot because of particle agglomeration. This increases relative lubricant viscosity over that for optimal dispersion and the divergence of viscosity with increasing volume fraction may occur at significantly lower volume fractions than with optimal dispersion. Poor dispersion has been shown to cause increased wear, and even oil gelation in extreme cases.

These factors are driving recent interest in developing in-engine separation technologies for decreasing soot loading. However, the problem with using currently available in-engine separation technologies, such as filtration and centrifugation, is that the effectiveness of these technologies is diminished with improved dispersion because improved dispersion often minimizes soot particle size. The present invention provides a solution to this problem. This invention is also suitable for separating particulates from other low dielectric fluids in addition to engine oils.

### SUMMARY OF THE INVENTION

This invention relates to a process for separating particulates from a low dielectric fluid containing such particulates, the process comprising: contacting the particulates with an acidic organic compound, a metal salt of an acidic organic compound, a basic organic compound, or a mixture of two or more thereof; applying an electric field to the low dielectric fluid; forming a particulates-lean phase and a particulates-rich phase in the dielectric fluid; and separating the particulates-lean phase from the particulates-rich phase.

In one embodiment, this invention relates to a process for operating an internal combustion engine equipped with an electrodecantation device, the process comprising: operating the engine using a lubricating oil composition to lubricate the engine, the lubricating oil composition comprising a base oil and a compound selected from an acidic organic compound, a metal salt of an acidic organic compound, a basic organic compound, or a mixture of two or more thereof, the lubricating oil composition accumulating particulates during operation of the engine resulting in the formation of a particulates-containing lubricating oil composition; advancing the particulates-containing lubricating oil composition from the engine to the electrodecantation device; applying a horizontally-directed electric field in the electrodecantation device to the particulates-containing oil composition to form a particulates-rich oil phase and a particulates-lean oil phase; separating the particulates-lean oil phase from the particulates-rich oil phase; and advancing the particulates-lean oil phase to the engine.

### BRIEF DESCRIPTION OF THE DRAWINGS

FIG. 1 is a flow sheet illustrating the inventive process in a particular form.

FIG. 2 is a flow sheet illustrating the inventive process in another particular form.

FIG. 3 is an illustration of the electrodecantation device used in Examples 1-3.

FIG. 4 is an illustration which discloses the results obtained for Example 1.

FIG. 5 is a graph which discloses the results obtained for Example 2.

FIG. 6 is a graph which discloses the results obtained for Example 3.

### DETAILED DESCRIPTION OF THE INVENTION

The term Alow dielectric fluid@ refers to a fluid having a dielectric constant of up to about 10, and in one embodiment about 1 to about 8, and in one embodiment from about 1 to about 5.

The term Ahydrocarbyl,@ when referring to groups attached to the remainder of a molecule, refers to groups having a purely hydrocarbon or predominantly hydrocarbon character within the context of this invention. Such groups include the following:

(1) Purely hydrocarbon groups; that is, aliphatic, alicyclic, aromatic, aliphatic- and alicyclic-substituted aromatic, aromatic-substituted aliphatic and alicyclic groups, and the like, as well as cyclic groups wherein the ring is completed through another portion of the molecule (that is, any two indicated substituents may together form an alicyclic group). Examples include methyl, octyl, cyclohexyl, phenyl, etc.

(2) Substituted hydrocarbon groups; that is, groups containing non-hydrocarbon substituents which do not alter the predominantly hydrocarbon character of the group. Examples include hydroxy, nitro, cyano, alkoxy, acyl, etc.

(3) Hetero groups; that is, groups which, while predominantly hydrocarbon in character, contain atoms other than carbon in a chain or ring otherwise composed of carbon atoms. Examples include nitrogen, oxygen and sulfur.

In general, no more than about three substituents or hetero atoms, and in one embodiment no more than one, will be present for each 10 carbon atoms in the hydrocarbyl group.

The term “lower” as used herein in conjunction with terms such as hydrocarbyl, alkyl, alkenyl, alkoxy, and the like, is intended to describe such groups which contain a total of up to 7 carbon atoms.

The term “oil-soluble” refers to a material that is soluble in mineral oil to the extent of at least about 0.01 gram per liter at 25° C.

The term “TBN” refers to total base number. This is the amount of acid (perchloric or hydrochloric) needed to neutralize all or part of a material=s basicity, expressed as milligrams of KOH per gram of sample.

Process for Separating Particulates from a Low Dielectric Fluid

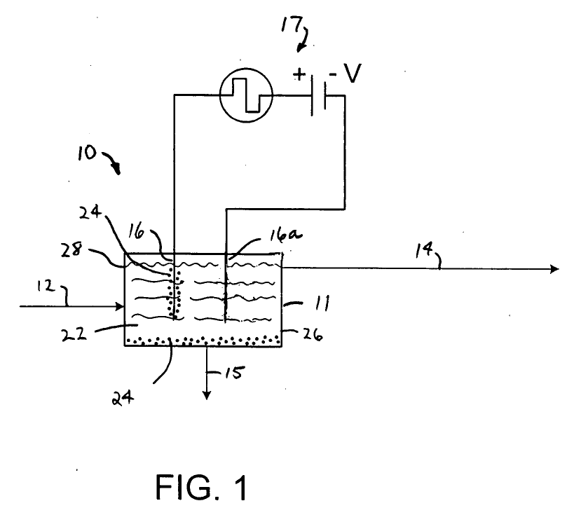

The inventive process will be described initially with reference to FIG. 1. Referring to FIG. 1, electrodecantation device 10 comprises cell 11, inlet line 12, outlet lines 14 and 15, and electrodes 16 and 16a which are positioned within cell 11. The electrodes 16 and 16a are connected to a power source 17 which provides an alternating current. The alternating current initially places a positive charge on electrode 16 and negative charge on electrode 16a. The charge on each electrode reverses when the alternating current reverses polarity.

A low dielectric fluid 22 containing particulates 24 and at least one compound selected from an acidic organic compound, a metal salt of an acidic organic compound, a basic organic compound, or a mixture of two or more of thereof, flows through line 12 into cell 11. The acidic organic compound, metal salt or basic organic compound contacts the particulates 24 and, in one embodiment, chemically charges the particulates 24. The particulates 24 are charged positively or negatively depending on whether they are contacted with an acidic organic compound, metal salt or basic organic compound. The power supply 17 establishes a horizontally directed alternating electric current that draws the particulates 24 to the electrode 16 at one polarity of the alternating current and then expels the particulates when the alternating current reverses polarity. The opposite occurs at electrode 16a. That is, when particulates 24 are drawn to electrode 16, they are expelled from electrode 16a, and vice versa. The concentration of charged particulates increases near electrode 16 when the electrode is oppositely charged relative to the charge on the particulates. This results in the formation of a particulates-rich phase near electrode 16. At the same time, the concentration of charged particulates near electrode 16a is reduced because the charge on the particulates 24 and the charge on electrode 16a are the same. This results in the formation of a particulates-lean phase near electrode 16a. The reversal of polarity prevents particulate buildup on the electrode surface; the timescale for reversing the polarity is long enough to allow a convective process to occur, but shorter than the time for particulate migration between electrodes. The particulates-rich phase is relatively dense as compared to the low dielectric fluid and as a result the particulates-rich phase sinks to the lower section 26 of the cell 11. The particulates-lean phase is displaced by the particulates-rich phase and rises to the upper section 28 of the cell 11. This creates a convective fluid flow with particulates 24 accumulating in the lower section 26, and the particulates-lean phase accumulating in the upper section 28. The particulates-lean phase is removed from the cell 11 through outlet line 14. The particulates 24 accumulated in the lower section 26 may be removed through outlet line 15. This process may be operated on a batch or continuous basis. The foregoing assumes that the particulates 24 have a higher density than the dielectric fluid 22. On the other hand, if the particulates 24 have a lower density than the dielectric fluid 22, the process occurs inversely with particulate accumulation occurring in the upper section 28 of the cell 11.

The cell 11 may be constructed of any material that is sufficient to provide it with desired strength and structural stability. Examples of the materials that may be used include silica glass as well as polymeric materials such as nylon, polypropylene, polycarbonate, and the like. In one embodiment, these materials are non-conductive to avoid leakage of electric current through the body of the cell 11.

The electrodes 16 and 16a may be constructed of any conductive material, with metals such as copper, steel or platinum being useful. The electrodes 16 and 16a may have any dimension that is suitable for the specific application. The electrodes may be in the form of parallel plates as depicted in FIG. 1, or alternatively in the form of concentric cylinders. The electrodes may have a porous or a non-porous construction. The electrodecantation device 10 may contain at least 2 electrodes, and in one embodiment any desired number of electrodes, for example, 2 to about 20 electrodes or more. The electrodes may be aligned in parallel spaced relationship with a gap of about 1 micrometer to about 5 cm between the electrodes. In one embodiment, the gap may be from about 0.5 mm to about 2 cm, and in one embodiment about 1 mm to about 1 cm.

The particulates 24 may be present in the dielectric fluid 22 entering the electrodecantation device at a concentration of up to about 50% by weight, and in one embodiment from about 10 parts per million by weight (ppmw) to about 50% by weight, and in one embodiment about 10 ppmw to about 35% by weight, and in one embodiment about 100 ppmw to about 20% by weight. The concentration of particulates 24 in the particulates-lean phase exiting the electrodecantation device 10 through line 14 may range from about zero to about 1% by weight, and in one embodiment about zero to about 0.5% by weight, and in one embodiment from about zero to about 0.1% by weight.

The temperature of the low dielectric fluid 22 flowing through the electrodecantation device 10 may range from about −30° C. to about 200° C., and in one embodiment from about −10° C. to about 150° C., and in one embodiment from about 0° C. to about 100° C., and in one embodiment about 10° C. to about 40° C.

The low dielectric fluid 22 may flow through the electrodecantation device 10 at a flow rate of about 0.05 to about 500 milliliters per minute (ml/min), and in one embodiment about 0.1 to about 100 ml/min, and in one embodiment about 0.1 to about 50 ml/mm, and in one embodiment about 0.1 to about 30 ml/mm, and in one embodiment about 0.1 to about 20 ml/mm, and in one embodiment about 0.1 to about 10 ml/mm, and in one embodiment about 0.5 to about 5 ml/min.

The Low Dielectric Fluid

The low dielectric fluid may be any organic liquid having a dielectric constant of up to about 10, and in one embodiment about 1 to about 8, and in one embodiment about 1 to about 5. In one embodiment, the low dielectric fluid is a non-polar liquid. The low dielectric fluid may be purely hydrocarbon; that is, aliphatic (e.g., hexane, octane, n-dodecane), alicyclic (e.g., cyclopentane, cyclohexane), aromatic (e.g., benzene), aliphatic-substituted aromatic (e.g., toluene, styrene), and the like. The low dielectric fluid may be hydrocarbon substituted with non-hydrocarbon groups (e.g., hydroxy, amino, halide, alkoxyl, etc.). The low dielectric fluid may be a natural oil, synthetic oil or mixture thereof. The natural oils include animal oils and vegetable oils (e.g., castor oil, lard oil) as well as mineral lubricating oils such as liquid petroleum oils and solvent treated or acid-treated mineral lubricating oils of the paraffinic, naphthenic or mixed paraffinic-naphthenic types. Oils derived from coal or shale are also useful.

Synthetic oils include hydrocarbon oils such as polymerized and interpolymerized olefins, alkylbenzenes, polyphenyls, alkylated diphenyl ethers, alkylated diphenyl sulfides, and derivatives, analogs and homologs thereof. The synthetic oils include alkylene oxide polymers and interpolymers and derivatives thereof where the terminal hydroxyl groups have been modified by esterification, etherification, etc.; esters of dicarboxylic acids (e.g., phthalic acid, succinic acid, alkyl succinic acids, alkenyl succinic acids, etc.) with a variety of alcohols (e.g., butyl alcohol, hexyl alcohol, dodecyl alcohol, 2-ethylhexyl alcohol, ethylene glycol, etc.); and esters made from C₅ to C₁₂ monocarboxylic acids and polyols or polyol ethers.

The low dielectric fluid may be a polyalphaolefin (PAO), a silicone oil, or an oil derived from Fischer-Tropsch synthesized hydrocarbons. The low dielectric fluid may be a fluorinated organic liquid.

Unrefined, refined and rerefined oils, either natural or synthetic (as well as mixtures of two or more of any of these) of the type disclosed hereinabove can be used as the low dielectric fluid.

The low dielectric fluid may be any of the base oils in Groups I-V as specified in the American Petroleum Institute (API) Base Oil Interchangeability Guidelines. The five base oil groups are as follows:

| Base Oil | | | | Viscosity |
|---|---|---|---|---|
| Category | Sulfur (%) | | Saturates(%) | Index |
| Group I | >0.03 | and/or | <90 | 80 to |
| | | | | 120 |
| Group II | ≦0.03 | and | ≧90 | 80 to |
| | | | | 120 |
| Group III | ≦0.03 | and | ≧90 | ≧120 |

| | |
|---|---|
| Group IV | All polyalphaolefins (PAOs) |
| Group V | All others not included in Groups I, II, III or IV |

Groups I, II and III are mineral oil base stocks.

The low dielectric fluid may be a crankcase lubricating oil for a spark-ignited or compression-ignited internal combustion engine, including automobile engines, truck engines, two-cycle engines, and the like. The low dielectric fluid may be a lubricant for a stationary power engine or turbine, and the like. The low dielectric fluid may be a transmission fluid, transaxle lubricant, gear oil, metal-working fluid, hydraulic fluid, compressor oil, transformer oil, and the like.

The low dielectric fluid may be a low-viscosity, non-volatile oil used in mining in the beneficiation of ores (e.g., iron ore). The low dielectric fluid may be a fluid used to separate ceramic powders during the manufacture of ceramics. The low dielectric fluid may be a fluid used in the processing or purification of pharmaceuticals. The low dielectric fluid may be a fluid used to separate proteins, microorganisms, and the like, from biological fluids.

The Particulates

The particulates may be organic, inorganic, or a mixture thereof. The particulates may have any shape or size. The particulates may have an average particle size of about 10 nanometers to about 100 microns, and in one embodiment about 0.1 to about 50 microns, and in one embodiment about 0.1 to about 20 microns, and in one embodiment about 0.1 to about 10 microns, and in one embodiment about 0.1 to about 4 microns, and in one embodiment about 0.1 to about 1 micron, and in one embodiment about 0.1 to about 0.5 microns.

The particulates may have one or more sites on their surface that is reactive with the acidic organic compound, metal salt or basic organic compound used with the inventive process. Examples of such reactive sites include carboxylic acid groups, phenolic groups, basic sites such as amino groups, as well as other reactive sites such as ester, metal oxide or metal hydroxide groups.

Examples of particulates that may be separated from low dielectric fluids in accordance with the inventive process include: soot which accumulates in diesel engine lubricants; organic or inorganic particulates (e.g., metallic particulates) that accumulate in hydraulic fluids, transmission fluids, gear oils, and the like; ore particulates contained in mining beneficiation fluids; ceramic particulates contained in fluids used to process or separate ceramic materials; proteins, microorganisms, and the like, contained in biological fluids; pharmaceutical particulates that accumulate in fluids used to process or purify pharmaceutical products; etc.

The Acidic Organic Compound

The acidic organic compound may be an organic sulfur acid, a carboxylic acid or derivative thereof, or phenol. The acidic organic compound may be a hydrocarbyl substituted saligenin or a salixarate derivative. The acidic organic compound may be an organic phosphorus acid. Mixtures of two or more of the foregoing acids may be used.

The organic sulfur acids may be oil-soluble organic sulfur acids such as sulfonic, sulfamic, thiosulfonic, sulfinic, sulfenic, partial ester sulfuric, sulfurous and thiosulfuric acid. Generally they are salts of aliphatic or aromatic sulfonic acids. The sulfonic acids include the mono- or poly-nuclear aromatic or cycloaliphatic compounds.

The carboxylic acids include aliphatic, cycloaliphatic, and aromatic mono- and polybasic carboxylic acids such as the naphthenic acids, alkyl- or alkenyl-substituted cyclopentanoic acids, alkyl- or alkenyl-substituted cyclohexanoic acids, alkyl- or alkenyl-substituted aromatic carboxylic acids. The aliphatic acids generally contain at least about 8 carbon atoms, and in one embodiment at least about 12 carbon atoms. Usually they have no more than about 500 carbon atoms. The cycloaliphatic and aliphatic carboxylic acids can be saturated or unsaturated.

A useful group of carboxylic acids are the oil-soluble aromatic carboxylic acids. These acids may be represented by the formula:

(R*)ₐ—Ar*(CXXH)ₘ (I)

wherein in Formula (I), R* is an aliphatic hydrocarbyl group of about 4 to about 400 carbon atoms, a is an integer of from one to four, Ar* is a polyvalent aromatic hydrocarbon nucleus of up to about 14 carbon atoms, each X is independently a sulfur or oxygen atom, and m is an integer of from one to four with the proviso that R* and a are such that there is an average of at least about 8 aliphatic carbon atoms provided by the R* groups for each acid molecule.

A useful group of carboxylic acids are the aliphatic-hydrocarbon substituted salicylic acids wherein each aliphatic hydrocarbon substituent contains an average of at least about 8 carbon atoms, and in one embodiment at least about 16 carbon atoms per substituent, and the acids contain one to three substituents per molecule. A useful aliphatic-hydrocarbon substituted salicylic acid is C₁₆-C₁₈ alkyl salicylic acid.

A group of carboxylic acid derivatives that are useful are the lactones represented by the formula

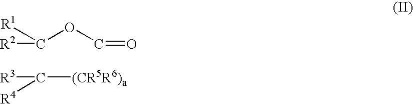

wherein in Formula (II), R¹, R², R³, R⁴, R⁵ and R⁶ are independently H, hydrocarbyl groups or hydroxy substituted hydrocarbyl groups of from 1 to about 30 carbon atoms, with the proviso that the total number of carbon atoms must be sufficient to render the lactones oil soluble; R² and R³ can be linked together to form an aliphatic or aromatic ring; and a is a number in the range of zero to 4. A useful lactone can be prepared by reacting an alkyl (e.g., dodecyl) phenol with glyoxylic acid at a molar ratio of about 2:1.

The phenols may be represented by the general formula

(R*)ₐ—(Ar*)—(OH)ₘ (III)

wherein in Formula (III), R*, a, Ar*, and m have the same meaning as described hereinabove with reference to Formula (I).

The hydrocarbyl-substituted saligenins may be represented by the formula

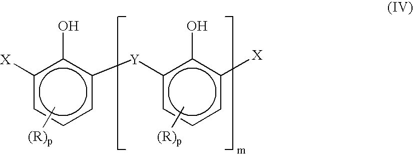

wherein in Formula (IV): each X independently is —CHO or —CH₂OH; each Y independently is —CH₂— or —CH₂OCH₂—; wherein the —CHO groups comprise at least about 10 mole percent of the X and Y groups; each R is independently a hydrocarbyl group containing 1 to about 60 carbon atoms; m is 0 to about 10; and each p is independently 0, 1, 2, or 3; provided that at least one aromatic ring contains an R substituent and that the total number of carbon atoms in all R groups is at least 7; and further provided that if m is 1 or greater, then one of the X groups can be —H. Each R may contain about 7 to about 28 carbon atoms, and in one embodiment about 9 to about 18 carbon atoms.

The salixarate derivative may be a compound comprising at least one unit of formula (V-A) or formula (V-B)

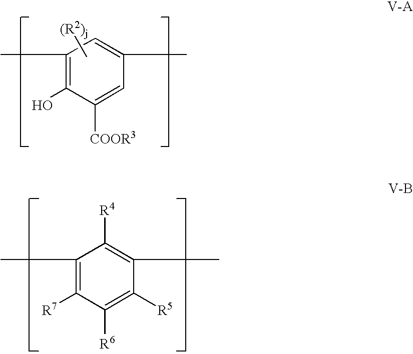

each end of the compound having a terminal group of formula (V-C) or formula (V-D):

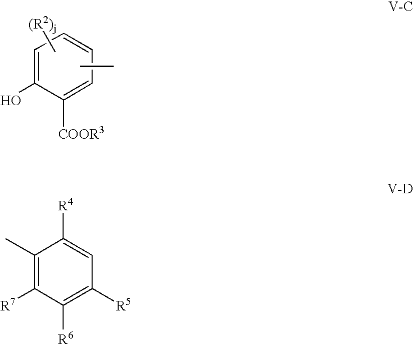

such groups being linked by divalent bridging groups A, which may be the same or different for each linkage; wherein in formulae (V-A) to (V-D), R³ is hydrogen or a hydrocarbyl group; R² is hydroxyl or a hydrocarbyl group and j is 0, 1, or 2; R⁶ is hydrogen, a hydrocarbyl group, or a hetero-substituted hydrocarbyl group; either R⁴ is hydroxyl and R⁵ and R⁷ are independently either hydrogen, a hydrocarbyl group, or hetero-substituted hydrocarbyl group, or else R⁵ and R⁷ are both hydroxyl and R⁴ is hydrogen, a hydrocarbyl group, or a hetero-substituted hydrocarbyl group; provided that at least one of R⁴, R⁵, R⁶ and R⁷ is hydrocarbyl containing at least about 8 carbon atoms; and wherein the molecules on average contain at least one unit (V-A) or (V-C) and at least one of the unit (V-B) or (V-D) and the ratio of the total number of units (V-A) and (V-C) to the total number of units of (V-B) and (V-D) in the composition is about 0.1:1 to about 2:1. The divalent bridging group A, which may be the same or different in each occurrence, includes —CH₂— (methylene bridge) and —CH₂OCH₂— (ether bridge), either of which may be derived from formaldehyde or a formaldehyde equivalent (e.g., paraform, formalin). Salixarate derivatives and methods of their preparation are described in greater detail in U.S. Pat. No. 6,200,936 and PCT Publication WO 01/56968, which are incorporated herein by reference. It is believed that the salixarate derivatives have a predominantly linear, rather than macrocyclic, structure, although both structures are intended to be encompassed by the term “salixarate.”

The phosphorus-containing acids may be represented by the formula

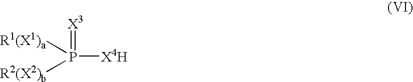

wherein in formula (VI): X¹, X², X³ and X⁴ are independently oxygen or sulfur, a and b are independently zero or one, and R¹ and R² are independently hydrocarbyl groups. Illustrative examples include: dihydrocarbyl phosphinodithioic acids, S-hydrocarbyl hydrocarbyl phosphonotrithioic acids, O-hydrocarbyl hydrocarbyl phosphinodithioic acids, S,S-dihydrocarbyl phosphorotetrathioic acids, O,S-dihydrocarbyl phosphorotrithioic acids, O,O-dihydrocarbyl phosphorodithioic acids, and the like.

Useful phosphorus-containing acids are phosphorus- and sulfur-containing acids. These include those acids wherein in Formula (VI) at least one X³ or X⁴ is sulfur, and in one embodiment both X³ and X⁴ are sulfur, at least one X¹ or X² is oxygen or sulfur, and in one embodiment both X¹ and X² are oxygen, and a and b are each 1. Mixtures of these acids may be employed in accordance with this invention.

R¹ and R² in formula (VI) are independently hydrocarbyl groups that are preferably free from acetylenic unsaturation and usually also from ethylenic unsaturation and in one embodiment have from about 1 to about 50 carbon atoms, and in one embodiment from about 1 to about 30 carbon atoms, and in one embodiment from about 3 to about 18 carbon atoms, and in one embodiment from about 3 to about 8 carbon atoms. Each R¹ and R² can be the same as the other, although they may be different and either or both may be mixtures. Examples of R¹ and R² groups include isopropyl, n-butyl, isobutyl, amyl, 4-methyl-2-pentyl, isooctyl, decyl, dodecyl, tetradecyl, 2-pentenyl, dodecenyl, phenyl, naphthyl, alkylphenyl, alkylnaphthyl, phenylalkyl, naphthylalkyl, alkylphenylalkyl, alkylnaphthylalkyl, and mixtures thereof. Particular examples of useful mixtures include, for example, isopropyl/n-butyl; isopropyl/secondary butyl; isopropyl/4-methyl-2-pentyl; isopropyl/2-ethyl-1-hexyl; isopropyl/isooctyl; isopropyl/decyl; isopropyl/dodecyl; and isopropyl/tridecyl.

In one embodiment, the phosphorus-containing compound represented by formula (VI) is a compound where a and b are each 1, X¹ and X² are each O, and R¹ and R² are derived from one or more primary alcohols, one or more secondary alcohols, or a mixture of at least one primary alcohol and at least one secondary alcohol. Examples of useful alcohol mixtures include: isopropyl alcohol and isoamyl alcohol; isopropyl alcohol and isooctyl alcohol; secondary butyl alcohol and isooctyl alcohol; n-butyl alcohol and n-octyl alcohol; n-pentyl alcohol and 2-ethyl-1 -hexyl alcohol; isobutyl alcohol and n-hexyl alcohol; isobutyl alcohol and isoamyl alcohol; isopropyl alcohol and 2-methyl-4-pentyl alcohol; isopropyl alcohol and sec-butyl alcohol; isopropyl alcohol and isooctyl alcohol; isopropyl alcohol, n-hexyl alcohol and isooctyl alcohol, etc. These include a mixture of about 40 to about 60 mole % 4-methyl-2-pentyl alcohol and about 60 to about 40 mole % isopropyl alcohol; a mixture of about 40 mole % isooctyl alcohol and about 60 mole % isopropyl alcohol; a mixture of about 40 mole % 2-ethylhexyl alcohol and about 60 mole % isopropyl alcohol; and a mixture of about 35 mole % primary amyl alcohol and about 65 mole % isobutyl alcohol.

The acidic organic compound may be present in the low dielectric fluid at a concentration of up to about 50% by weight, and in one embodiment about 0.1 to about 50% by weight, and in one embodiment about 0.1 to about 25% by weight, and in one embodiment from about 0.1 to about 10% by weight.

The Metal Salt of an Acidic Organic Compound

The metal salt of an acidic organic compound may be any metal salt of any of the foregoing acidic organic compounds. The metal may be a Group IA, IIA or IIB metal, or a transition metal such as aluminum, lead, tin, iron, molybdenum, manganese, cobalt, nickel or bismuth. Sodium, potassium, lithium, calcium and zinc are useful. Mixtures of two or more of the foregoing metals may be used. Mixtures of two or more metal salts may be used.

The metal salt may be employed in the low dielectric fluid at a concentration of up to about 50% by weight, and in one embodiment about 0.5 to about 50% by weight, and in one embodiment about 0.5 to about 25% by weight, and in one embodiment about 0.5 to about 10 percent by weight.

The Basic Organic Compound

The basic organic compound may be an acylated nitrogen containing compound, a hydrocarbyl amine, the reaction product of a hydrocarbyl substituted phenol with an aldehyde and an amine, or a mixture of two or more thereof. The basic organic compound may have a TBN in the range of about 1 to about 100, and in one embodiment about 10 to about 65. The basic organic compound may be present in the low dielectric fluid at a concentration of up to about 50% by weight, and in one embodiment about 0.5 to about 50% by weight, and in one embodiment about 0.5 to about 25% by weight, and in one embodiment about 0.5 to about 10% by weight.

(i) The Acylated Nitrogen Containing Compound

The acylated nitrogen containing compound may be made by reacting a carboxylic acid acylating agent with an amino compound. The acylating agent may be linked to the amino compound through an imido, amido, amidine or salt linkage. The substituent comprised of at least about 10 aliphatic carbon atoms may be in either the carboxylic acid acylating agent derived portion of the molecule or in the amino compound derived portion of the molecule.

Illustrative substituent goups containing at least about 10 aliphatic carbon atoms include n-decyl, n-dodecyl, tetrapropylene, n-octadecyl, oleyl, chlorooctadecyl, triicontanyl, etc. Generally, these substituents are hydrocarbyl groups made from homo- or interpolymers (e.g., copolymers, terpolymers) of mono- or di-olefins having 2 to about 10 carbon atoms, such as ethylene, propylene, 1-butene, isobutene, butadiene, isoprene, 1-hexene, 1-octene, etc. Typically, these olefins are 1-monoolefins. The substituent may also be derived from the halogenated (e.g., chlorinated or brominated) analogs of such homo- or interpolymers.

A useful source for the substituent groups are poly(isobutene)s obtained by polymerization of a C₄ refinery stream having a butene content of about 35 to about 75 weight percent and an isobutene content of about 30 to about 60 weight percent in the presence of a Lewis acid catalyst such as aluminum trichloride or boron trifluoride. These polybutenes contain predominantly isobutene repeating units.

In one embodiment, the substituent is a polyisobutene group derived from a polyisobutene having a high methylvinylidene isomer content, that is, at least about 50% methylvinylidene, and in one embodiment at least about 70% methylvinylidene. Suitable high methylvinylidene polyisobutenes include those prepared using boron trifluoride catalysts.

The acylating agent can vary from formic acid and its acyl derivatives to acylating agents having high molecular weight aliphatic substituents of up to about 5,000, 10,000 or 20,000 carbon atoms. In one embodiment, the acylating agent is a hydrocarbyl substituted succinic acid or anhydride containing hydrocarbyl substituent groups and succinic groups wherein the substituent groups are derived from a polyalkene such as polyisobutene. The acid or anhydride may be characterized by the presence within its structure of an average of at least about 0.9 succinic group for each equivalent weight of substituent groups, and in one embodiment about 0.9 to about 2.5 succinic groups for each equivalent weight of substituent groups. The polyalkene may have number average molecular weight (Mn) of at least about 700, and in one embodiment about 700 to about 3000, and in one embodiment about 900 to about 2200. The ratio between the weight average molecular weight (Mw) and the (Mn) (that is, Mw/Mn) may range from about 1 to about 10, and in one embodiment about 1.5 to about 5, and in one embodiment about 2.5 to about 5. For purposes of this invention, the number of equivalent weights of substituent groups is deemed to be the number corresponding to the quotient obtained by dividing the Mn value of the polyalkene from which the substituent is derived into the total weight of the substituent groups present in the substituted succinic acid or anhydride.

The amino compound may be characterized by the presence within its structure of at least one HN<group and can be a monoamine or polyamine. Mixtures of two or more amino compounds can be used in the reaction with one or more acylating reagents. In one embodiment, the amino compound contains at least one primary amino group (i.e., —NH₂). In one embodiment, the amine is a polyamine, for example, a polyamine containing at least two —NH— groups, either or both of which are primary or secondary amines. The amines may be aliphatic, cycloaliphatic, aromatic or heterocyclic amines. Hydroxy substituted amines, such as alkanol amines (e.g., mono- or diethanol amine), and hydroxy (polyhydrocarbyloxy) anologs of such alkanol amines may be used.

Among the useful amines are the alkylene polyamines, including the polyalkylene polyamines. The alkylene polyamines include those represented by the formula

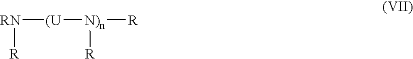

wherein in Formula (VII), n is from 1 to about 14; each R is independently a hydrogen atom, a hydrocarbyl group or a hydroxy-substituted or amine-substituted hydrocarbyl group having up to about 30 atoms, or two R groups on different nitrogen atoms can be joined together to form a U group, with the proviso that at least one R group is a hydrogen atom and U is an alkylene group of about 2 to about 10 carbon atoms. U may be ethylene or propylene. Alkylene polyamines where each R is hydrogen or an amino-substituted hydrocarbyl group with the ethylene polyamines and mixtures of ethylene polyamines are useful. Usually n will have an average value of from about 2 to about 10. Such alkylene polyamines include methylene polyamines, ethylene polyamines, propylene polyamines, butylene polyamines, pentylene polyamines, hexylene polyamines, heptylene polyamines, etc. The higher homologs of such amines and related amino alkyl-substituted piperazines are also included.

Alkylene polyamines that are useful include ethylene diamine, diethylene triamine, triethylene tetramine, tetraethylene pentamine, pentaethylene hexamine, propylene diamine, trimethylene diamine, hexamethylene diamine, decamethylene diamine, octamethylene diamine, di(heptamethylene) triamine, tripropylene tetramine, trimethylene diamine, di(trimethylene)triamine, N-(2-aminoethyl)piperazine, 1,4-bis(2-aminoethyl)piperazine, and the like. Higher homologs such as those obtained by condensing two or more of the above-illustrated alkylene amines may be used. Mixtures of two or more of any of the afore-described polyamines may be used.

Useful polyamines include those resulting from stripping polyamine mixtures. In this instance, lower molecular weight polyamines and volatile contaminants are removed from an alkylene polyamine mixture to leave as residue what is often termed Apolyamine bottoms”. In general, alkylene polyamine bottoms can be characterized as having less than about 2% by weight, and in one embodiment less than about 1 % by weight material boiling below about 200° C.

The acylated nitrogen containing compounds include amine salts, amides, imides, amidines, amidic acids, amidic salts and imidazolines as well as mixtures thereof. To prepare the acylated nitrogen-containing compounds from the acylating agents and the amino compounds, one or more acylating reagents and one or more amino compounds may be heated, optionally in the presence of a normally liquid, substantially inert organic liquid solvent/diluent, at temperatures in the range of 80° C. up to the decomposition point of any of the reactants or the product but normally at temperatures in the range of about 100° C. to about 300° C., provided 300° C. does not exceed the decomposition point of any of the reactants or the product. Temperatures of about 125° C. to about 250° C. may be used. The acylating agent and the amino compound may be reacted in amounts sufficient to provide from about 0.5 to about 3 moles of amino compound per equivalent of acylating agent. The number of equivalents of the acylating agent will vary with the number of carboxy groups present therein. In determining the number of equivalents of the acylating agent, those carboxyl functions which are not capable of reacting as a carboxylic acid acylating agent are excluded. In general, however, there is one equivalent of acylating agent for each carboxy group in the acylating agent.

(ii) The Hydrocarbyl Amine

The hydrocarbyl amine may be the reaction product of a hydrocarbyl halide with an amine. Any of the hydrocarbyl groups and any of the amines described above may be used. In one embodiment, the hydrocarbyl group has a number average molecular weight of about 600 to about 3000. These reaction products are sometimes referred to as Aamine dispersants@. Examples include the products made by reacting a polyisobutene halide (e.g., chloride or bromide) with an alkylene polyamine (e.g., ethylene diamine). These reaction products are described in U.S. Pat. Nos. 3,275,554; 3,438,757; 3,454,555; and 3,565,804, which are incorporated herein by reference.

(iii) Reaction Product of Hydrocarbyl Substituted Phenol with Aldehyde and Amine

The reaction product of a hydrocarbyl substituted phenol with an aldehyde and amine may be referred to as a Mannich dispersant. The hydrocarbyl group and the amine may be any of those discussed above. In one embodiment, the hydrocarbyl group has a molecular weight of about 600 to about 3000. The aldehyde may be formaldehyde. The molar ratio of hydrocarbyl substituted phenol to aldehyde to amine may be about 1:0.1-10:0.1-10. These reaction products are disclosed in U.S. Pat. Nos. 3,649,229; 3,697,574; 3,725,277; 3,725,480; 3,726,882; and 3,980,569, which are incorporated herein by reference.

Process for Operating an Internal Combustion Engine Using an Electrodecantation Device to Separate Particulates from the Lubricating Oil

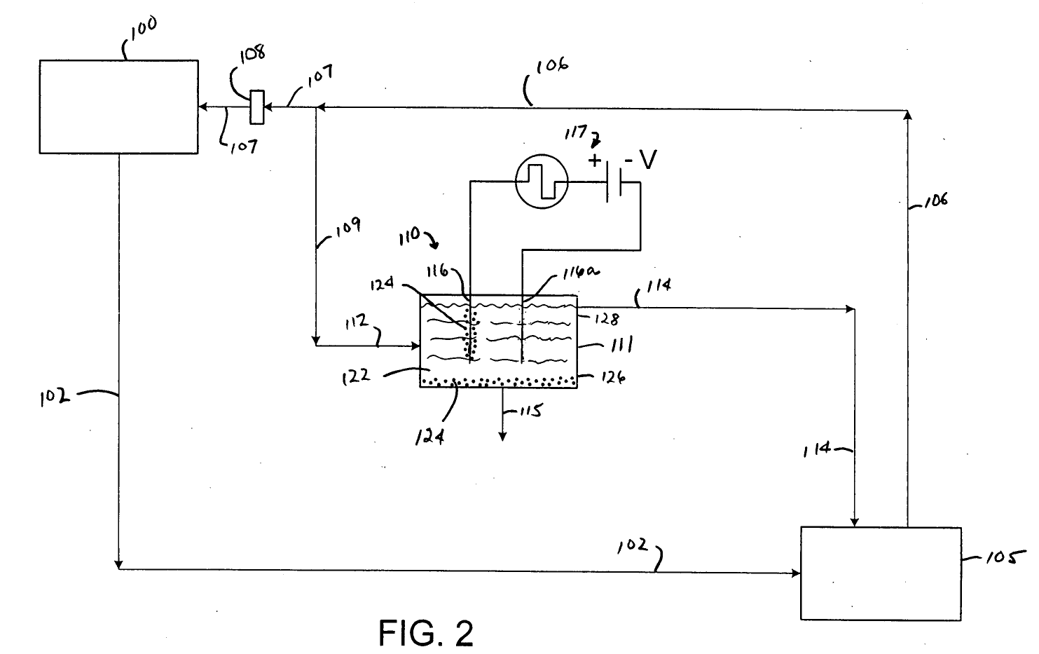

The invention will now be described with respect to one of its embodiments which relates to a process for removing particulates (for example, soot particulates) from the lubricating oil used to lubricate an internal combustion engine while the engine is operated. Referring to FIG. 2, internal combustion engine 100 is equipped with an oil sump 105 and an electrodecantation device 110. Electrodecantation device 110 has a cell 111, an inlet line 112, an outlet line 114, and electrodes 116 and 116a positioned within the cell 111. The electrodes 116 and 116a are connected to a power source 117 which provides an alternating current. During the operation of engine 100, lubricating oil 122 is circulated from engine 100 through line 102 to sump 105, and then from sump 105 through lines 106 and 107 through filter 108 back to engine 100. During the operation of the engine 100 particulates 124 accumulate in the lubricating oil 122 and in order to extend the drain cycle for the lubricating oil a portion of the lubricating oil flows through bypass line 109 to line 112 and then into electrodecantation device 110. The flow of lubricating oil 122 through bypass line 109 may be up to about 20% by weight, and in one embodiment about 0.01 to about 20% by weight, and in one embodiment about 0.01 to about 10% by weight of the lubricating oil flowing through line 106. The lubricating oil 122 comprises a base oil and at least one compound selected from an acidic organic compound, a metal salt of an acidic organic compound, a basic organic compound, or a mixture of two or more thereof, as discussed above. The acidic organic compound, metal salt or basic organic compound contact the particulates 124, and in one embodiment, chemically charge the particulates 124. The particulates 124 are charged positively or negatively depending on whether they are contacted with an acidic organic compound, metal salt or basic organic compound. The power supply 117 establishes a horizontally directed alternating electric current that draws the particulates 124 to the electrode 116 at one polarity of the alternating current and then expels the particulates when the alternating current reverses polarity. The opposite occurs at electrode 116a. That is, when particulates 124 are drawn to electrode 116, they are expelled from electrode 116a, and vice versa. The concentration of charged particulates increases near electrode 116 when the electrode is oppositely charged relative to the charge on the particulates. This results in the formation of a particulates-rich oil phase near electrode 116. At the same time, the concentration of charged particulates near electrode 116a is reduced because the charge on the particulates 124 and the charge on electrode 116a are the same. This results in the formation of a particulates-lean oil phase near electrode 116a. The reversal of polarity prevents particulate buildup on the electrode surface; the timescale for reversing the polarity is long enough to allow a convective process to occur, but shorter than the time for particulate migration between electrodes. The particulates-rich oil phase is relatively dense as compared to the lubricating oil 122 and as a result the particulates-rich oil phase sinks to the lower section 126 of the cell 111. The particulates-lean oil phase is displaced by the particulates-rich phase and rises to the upper section 128 of the cell 111. This creates a convective fluid flow with particulates 124 accumulating in the lower section 126, and the particulates-lean oil phase accumulating in the upper section 128. The particulates-lean oil phase is removed from the cell 111 through outlet line 114.

The particulates-lean oil phase flows from the upper section 128 of cel 111 through line 114 to sump 105. In sump 105 the particulates-lean oil phase from electrodecantation device 110 mixes with the rest of the oil in sump 105. The particulates 124 that collect at the bottom of cell 111 may be removed through line 115 when the lubricating oil for the internal combustion engine 100 is changed. By removing the particulates 124 from the lubricating oil 122 during the operation of the engine 100 using electrodecantation device 110, the time required between drain intervals or the drain cycle for the engine is extended. The foregoing assumes that the particulates 124 have a higher density than the lubricating oil 122. On the other hand, if the particulates 124 have a lower density than the lubricating oil 122, the process occurs inversely with particulate accumulation occurring in the upper section 128 of the device 110.

The internal combustion engine 100 may be any internal combustion engine. The internal combustion engine 100 may be a spark-ignited (or gasoline powered) or a compression-ignited (or diesel) engine. These engines include automobile and truck engines, two-cycle engines, aviation piston engines, marine and railroad diesel engines, and the like. Included are on- and off-highway engines. The diesel engines include those for both mobile and stationary power plants. The diesel engines include those used in urban buses, as well as all classes of trucks. The diesel engines may be of the two-stroke per cycle or four-stroke per cycle type. The diesel engines include heavy duty diesel engines.

The cell 111 may be constructed of any material that is sufficient to provide it with desired strength and structural stability. Examples of the materials that may be used include silica glass as well as polymeric materials such as nylon, polypropylene, polycarbonate, and the like. In one embodiment, these materials are non-conductive to avoid leakage of electric current through the body of the cell 111.

The electrodes 116 and 116a may be constructed of any conductive material, with metals such as copper, steel or platinum being useful. The electrodes 116 and 116a may have any dimension that is suitable for the specific application. The electrodes may be in the form of parallel plates as depicted in FIG. 2, or alternatively in the form of concentric cylinders. The electrodes may have a porous or a non-porous construction. The electrodecantation device 110 may contain at least 2 electrodes, and in one embodiment any desired number of electrodes, for example, 2 to about 20 electrodes or more. The electrodes may be aligned in parallel spaced relationship with a gap of about 1 micrometer to about 5 cm between the electrodes. In one embodiment, the gap may be from about 0.5 mm to about 2 cm, and in one embodiment about 1 mm to about 1 cm.

The particulates 124 may be present in the lubricating oil 122 entering the electrodecantation device 110 at a concentration of up to about 50% by weight, and in one embodiment from about 10 parts per million by weight (ppmw) to about 50% by weight, and in one embodiment about 10 ppmw to about 35% by weight, and in one embodiment about 100 ppmw to about 20% by weight. The concentration of particulates 124 in the particulates-lean oil phase exiting the electrodecantation device 110 through line 114 may range from about zero to about 1% by weight, and in one embodiment about zero to about 0.5% by weight, and in one embodiment from about zero to about 0.1% by weight.

The temperature of the lubricating oil 122 flowing through the electrodecantation device 110 may range from about −30° C. to about 200° C., and in one embodiment from about −10° C. to about 150° C., and in one embodiment from about 0° C. to about 100° C., and in one embodiment about 10° C. to about 40° C.

The lubricating oil 122 may flow through the electrodecantation device 110 at a flow rate of about 0.05 to about 500 milliliters per minute (ml/min), and in one embodiment about 0.1 to about 100 ml/min, and in one embodiment about 0.1 to about 50 ml/mm, and in one embodiment about 0.1 to about 30 ml/mm, and in one embodiment about 0.1 to about 20 ml/mm, and in one embodiment about 0.1 to about 10 ml/mm, and in one embodiment about 0.5 to about 5 ml/min.

The lubricating oil composition 122 process may comprise one or more base oils which are generally present in a major amount. The base oil may be any of the natural or synthetic oils described above as being useful as a low dielectric fluid. The base oil may be present in an amount greater than about 60%, and in one embodiment greater than about 70%, and in one embodiment greater than about 80% by weight, and in one embodiment greater than about 85% by weight of the lubricating oil composition. The lubricating oil composition comprises an acidic organic compound, a metal salt of an acidic organic compound, a basic organic compound, or a mixture of two or more thereof, as discussed above. The basic organic, compound may be an acylated-nitrogen containing compound which typically functions as a dispersant. The metal salt may be an alkali or alkaline earth metal containing salt which typically functions as a detergent. The metal salt may be a metal salt of a phosphorus-containing compound which typically functions as an antiwear or extreme pressure (EP) additive.

The lubricating oil composition 122 may also contain other lubricant additives known in the art. These include, for example, corrosion-inhibiting agents, antioxidants, viscosity modifiers, dispersant viscosity index modifiers, pour point depressants, friction modifiers, antiwear agents, extreme pressure agents, dispersants, detergents, fluidity modifiers, copper passivators, anti-foam agents, etc. Each of the foregoing additives, when used, is used at a functionally effective amount to impart the desired properties to the lubricant. Generally, the concentration of each of these additives, when used, ranges from about 0.001% to about 20% by weight, and in one embodiment about 0.01% to about 10% by weight based on the total weight of the lubricating oil composition.

The foregoing lubricating oil additives can be added directly to the base oil to form the lubricating oil composition. In one embodiment, however, one or more of the additives are diluted with a substantially inert, normally liquid organic diluent such as mineral oil, synthetic oil, naphtha, alkylated (e.g., C₁₀-C₁₃ alkyl) benzene, toluene or xylene to form an additive concentrate. These concentrates usually contain from about 1% to about 99% by weight, and in one embodiment 10% to 90% by weight of such diluent. The concentrates may be added to the base oil to form the lubricating oil composition.

The lubricating oil composition may have a viscosity of up to about 16.3 cSt at 100° C., and in one embodiment about 5 to about 16.3 cSt at 100° C., and in one embodiment about 6 to about 13 cSt at 100° C.

The lubricating oil composition may have an SAE Viscosity Grade of 0W, 0W-20, 0W-30, 0W-40, 0W-50, 0W-60, 5W, 5W-20, 5W-30, 5W-40, 5W-50, 5W-60, 10W, 10W-20, 10W-30, 10W-40 or 10W-50. The viscosity grade may be SAE 15W-40, SAE 30, SAE 40 or SAE 20W-50.

The lubricating oil composition may be characterized by a sulfur content of up to about 1% by weight, and in one embodiment up to about 0.5% by weight.

The lubricating oil composition may be characterized by a phosphorus content of up to about 0.12% by weight, and in one embodiment about 0.03 to about 0.12% by weight, and in one embodiment about 0.03 to about 0.10% by weight, and in one embodiment about 0.03 to about 0.08% by weight, and in one embodiment about 0.03 to about 0.05% by weight.

The ash content of the lubricating oil composition as determined by the procedures in ASTM D-874-96 may be in the range of about 0.3 to about 1.4% by weight, and in one embodiment about 0.3 to about 1.2% by weight, and in one embodiment about 0.3 to about 1.0% by weight.

The lubricating oil composition may be characterized by a chlorine content of up to about 100 ppm, and in one embodiment up to about 50 ppm, and in one embodiment up to about 10 ppm.

### EXAMPLE 1

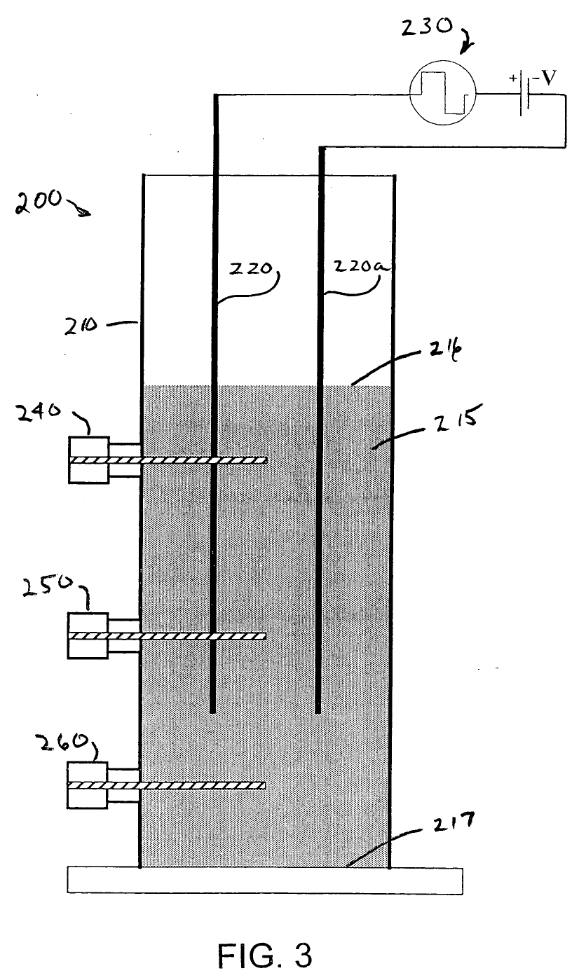

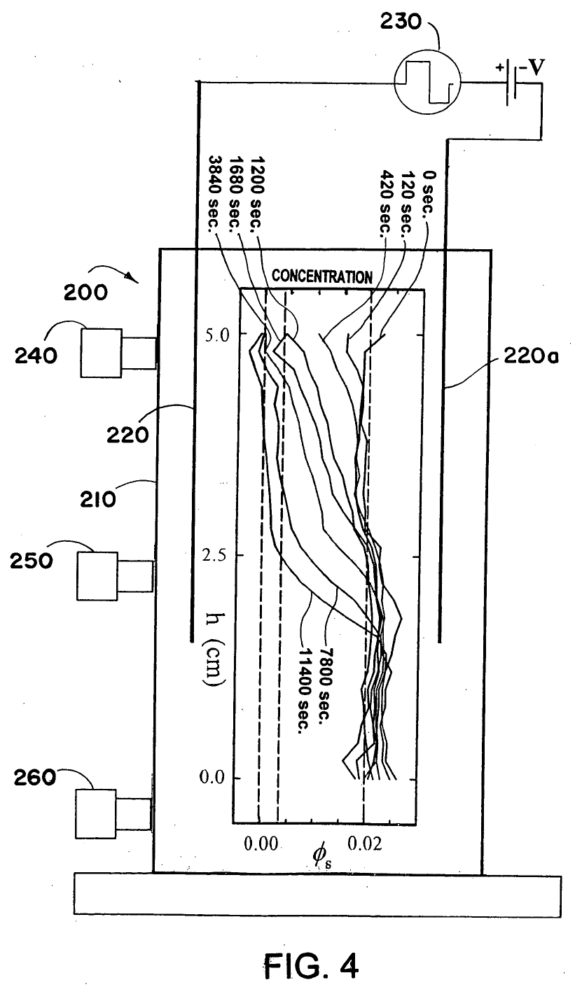

The electrodecantation device 200 illustrated in FIG. 3 is used to separate carbon black particulates from a dispersion of the particulates in a liquid mixture of n-dodecane and polyisobutenyl succinimide. The device 200 comprises cell 210, which has the dimensions of 2×2×15 cm, and electrodes 220 and 220a, each of which has a width of 1 cm and a thickness of 1 cm. The device 200 has a power source 230 for applying an alternating current. The device 200 also has ports 240, 250 and 260 for measuring the concentration of particulates The dispersion contains 2% by volume Black Pearls 130 carbon black (manufactured by Cabot Corporation) dispersed in a liquid mixture containing n-dodecane and 6% by weight polyisobutenyl succinimide (number average molecular weight (Mn)=3583; total base number (TBN)=19; total acid number (TAN)=2)). The carbon black is mixed in the n-dodecane and polyisobutenyl succinimide using a high speed shear mixer. The average particulate size of carbon black is 238 nm (measured by quasi-elastic light scattering); this size remains constant with time. The carbon black is well dispersed and uniformly distributed throughout the mixture. There is no noticeable settling after several days. The dispersion 215 is placed in the cell 210 at a temperature of 25° C. An electric field of 2 KV/m is applied to the dispersion. Samples from the three ports 240, 250 and 260 are analyzed for concentration of particulates using thermogavimetric analysis (TGA). The samples are taken at intervals of 0 seconds (i.e., the beginning of the test), 120 seconds, 420 seconds, 1200 seconds, 1680 seconds, 3840 seconds, 7800 seconds and 11,400 seconds. The results are plotted in FIG. 4 in terms of carbon black sediment by electric field. Each curve shows the concentration of particulates at various heights within the cell 210 after the indicated time interval for the application of electric field. The results indicate that the carbon black settles in the lower third of the cell.

### EXAMPLE 2

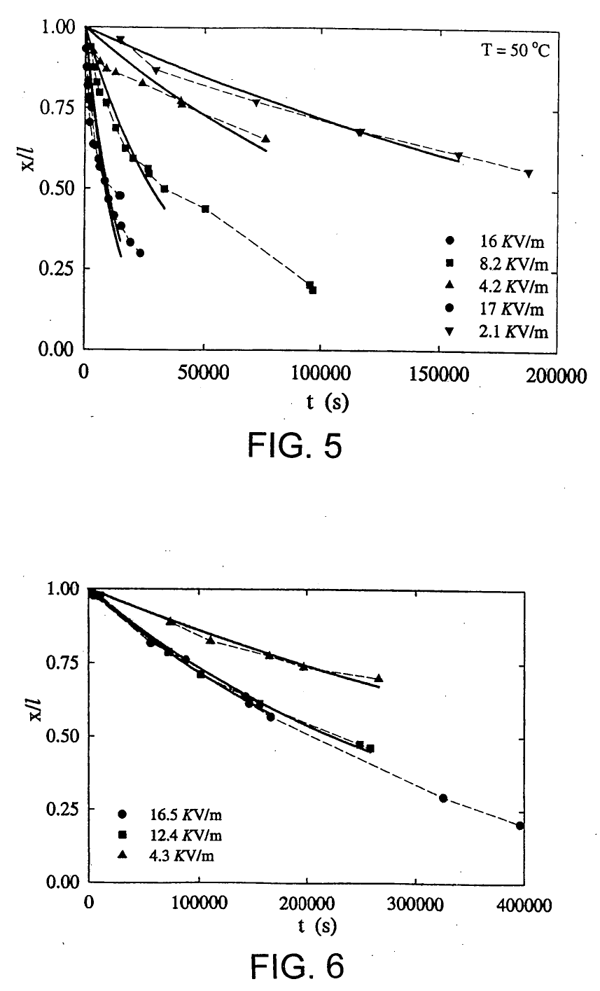

A dispersion of 2% by volume carbon black (BP130 from Cabot) in a mineral oil basestock containing 6% by weight of the polyisobutylene succinimide disclosed in Example 1 is prepared using a ball mill. The carbon black particulate size is 238 nm measured by quasi-elastic light scattering. The size does not change with time. The carbon black does not settle after several weeks. The dispersion is poured into the cell 210 illustrated in FIG. 3, and an electric field is applied to the electrodes 220 and 220a. The cell 210 and its contents are immersed in a constant temperature bath and maintained at 50° C. The concentration at various levels in the cell 210 is monitored by taking samples from the ports 240, 250 and 260. The concentration of carbon black is determined by TGA. This experiment is repeated using electric fields varying from 2.1 KV/m to 18.6 KV/m over various time periods. The results are shown in FIG. 5. This figure shows the relative height (X/I=1.00 is the top 216 of the dispersion 215 and X/I=0.00 is the bottom 217 of the cell 210) on the vertical axis and the time for applying the field on the horizontal axis. The data plotted in FIG. 5 shows the time required to remove all the carbon black (less than 0.2% by volume remaining) as a function of height in the cell. The data shows that more of the carbon black is driven to the bottom of the cell more quickly as the field strength increases.

### EXAMPLE 3

An end of test (EOT) drain oil from (the oil sump of) a GM 6.5L diesel engine test is used in the electrodecanation device 200 shown in FIG. 3. The engine test is the ARoller Follower Wear Test@ developed by the General Motors Corporation, November, 1993. The oil used in the test is an API CG-4/PC-7 type and a SAE 15W-40 viscosity grade. The oil contains 4.8% by weight a polyisobutyl succinimide (Mn=1945, TAN=2, TBN=50), the oil also containes detergents and antioxidants. The EOT oil contains 8.5% by weight particulates as determined by TGA. The particulates are well dispersed in the oil. The particulates have an average particle size of 191 nm. The dispersion is stable. The electrodecantation experiments are conducted at 50° C. The dispersion is placed in the cell 210. There is no settling of particulates in the cell 210 after 10 days with no electric field applied. The data is plotted in FIG. 6. The data shows the relative location (X/I=0.00 for the bottom 217 of cell 210 and X/I=1.00 for the top 216 of dispersion 215 in cell 210) of the particulate-lean oil phase (less than 0.4 weight % particulates) as a function of time after applying various electric fields. The data indicates that more of the carbon black is driven to the bottom of the cell more quickly as the field strength increases.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A process for separating particulates from a low dielectric fluid containing such particulates, the process comprising:
contacting the particulates with an acidic organic compound, a metal salt of an acidic organic compound, a basic organic compound, or a mixture of two or more thereof;
applying an electric field to the low dielectric fluid;
forming a particulates-lean phase and a particulates-rich phase in the dielectric fluid; and
separating the particulates-lean phase from the particulates-rich phase.

2. The process of claim 1 wherein the electric field is a horizontally directed electric field which is applied using alternating current.

3. The process of claim 1 wherein the electric current is applied using electrodes having a porous construction.

4. The process of claim 1 wherein the electric current is applied using electrodes having a non-porous construction.

5. The process of claim 1 wherein the electrodecantation device has an upper section and a lower section, the particulates-rich phase forms in the lower section of the electrodecantation device and the particulates-lean phase forms in the upper section of the electrodecantation device.

6. The process of claim 1 wherein the electrodecantation device has an upper section and a lower section, the particulates-rich phase forms in the upper section of the electrodecantation device and the particulates-lean phase forms in the lower section of the electrodecantation device.

7. The process of claim 1 wherein the low dielectric fluid comprises an organic liquid.

8. The process of claim 1 wherein the low dielectric fluid comprises a natural oil, synthetic oil, or mixture thereof.

9. The process of claim 1 wherein the low dielectric fluid comprises a purely hydrocarbon, a hydrocarbon substituted with non-hydrocarbon groups, a fatty acid, a silicone oil, a fluorinated organic liquid, a polyolphaolefin, a Fischer-Tropsch synthesized hydrocarbon, or a mixture of two or more thereof.

10. The process of claim 1 wherein the low dielectric fluid comprises a crankcase lubricating oil, gear oil, hydraulic fluid, transmission fluid, transaxle lubricant, compressor oil, transformer oil, metal-working fluid, or a mixture of two or more thereof.

11. The process of claim 1 wherein the particulates comprise soot, ore particulates, proteins or microorganisms, pharmaceutical particulates or ceramic powders.

12. The process of claim 1 wherein the acidic organic compound comprises a carboxylic acid, an organic sulfur acid, an organic phosphorus acid, a phenol, a hydrocarbyl substituted saligenin, a salixarate derivative, or a mixture of two or more thereof.

13. The process of claim 1 wherein the metal salt of an acidic organic compound comprises a metal salt of a carboxylic acid, an organic sulfur acid, an organic phosphorus acid, a phenol, a hydrocarbyl substituted saligenin, a salixarate derivative, or a mixture of two or more thereof.

14. The process of claim 1 wherein the basic organic compound comprises an acylated nitrogen containing compound, a hydrocarbyl amine, the reaction product of a hydrocarbyl substituted phenol with an aldehyde and an amine, or a mixture of two or more thereof.

15. A process for operating an internal combustion engine equipped with an electrodecantation device, the process comprising:
operating the engine using a lubricating oil composition to lubricate the engine, the lubricating oil composition comprising: a base oil; and a compound selected from an acidic organic compound, a metal salt of an acidic organic compound, a basic organic compound, or a mixture of two or more thereof; the lubricating oil composition accumulating particulates during operation of the engine resulting in the formation of a particulates-containing oil composition;
advancing the particulates-containing oil composition from the engine to the electrodecantation device;
applying a horizontally-directed electric field in the electrodecantation device to the particulates-containing oil composition to form a particulates-rich oil phase and a particulates-lean oil phase:
separating the particulates-lean oil phase from the particulates-rich oil phase; and
advancing the particulates-lean oil-phase to the engine.

16. The process of claim 15 wherein the base oil comprises a natural oil, a synthetic oil, or mixture thereof.

17. The process of claim 15 wherein the acidic organic compound comprises a carboxylic acid, an organic sulfur acid, an organic phosphorus acid, a phenol, a hydrocarbyl substituted saligenin, a salixarate derivative, or a mixture of two or more thereof.

18. The process of claim 15 wherein the metal salt of an acidic organic compound comprises a metal salt of a carboxylic acid, an organic sulfur acid, an organic phosphorus acid, a phenol, a hydrocarbyl substituted saligenin, a salixarate derivative, or a mixture of two or more thereof.

19. The process of claim 15 wherein the basic organic compound comprises an acylated nitrogen containing compound, a hydrocarbyl amine, the reaction product of a hydrocarbyl substituted phenol with an aldehyde and an amine, or a mixture of two or more thereof.

20. The process of claim 15 wherein the lubricating oil composition further comprises a corrosion-inhibiting agent, antioxidant, viscosity modifier, dispersant viscosity index modifier, pour point depressant, friction modifier, antiwear agent, extreme pressure agent, dispersant, detergent, fluidity modifier, copper passivator, anti-foam agent, or mixture of two or more thereof.
